(19) United States
(12) Patent Application Publication
(10) Pub. No.: US 2002/0143965 A1
(43) Pub. Date: Oct. 3, 2002

(54) Server application initiated affinity within networks performing workload balancing

(75) Inventor: John A. Aiken JR., Raleigh, NC (US)

Correspondence Address: Jerry W. Herndon, IBM Corporation T81/503, PO Box 12195, Research Triangle Park, NC, 27709, US

(73) Assignee: International Business Machines Corporation, Armonk, NY (US)

(21) Appl. No.: 09/825,071

(22) Filed: Apr. 3, 2001

(51) Int. Cl. G06F 15/16

(52) U.S. Cl. 709/229; 709/105

(57) ABSTRACT

Methods, systems, and computer program products for establishing an affinity between a particular server application and a particular client in a computing network, where that network performs workload balancing. A server application explicitly requests to start an affinity for a particular client (or client group), based on application-specific considerations, thereby causing normal workload balancing to be bypassed for subsequent connection requests from that source. The application may also explicitly end an affinity, and/or may extend an affinity. Preferably, each affinity has a maximum duration and will therefore expire automatically if not explicitly ended. No changes are required on client devices or in client software, and there is no dependency on a client to support cookies.

### BACKGROUND OF THE INVENTION

1. Related Invention

The present invention is related to commonly-assigned U.S. Pat. No. ______ (Ser. No. 09/______, filed concurrently herewith), entitled “Automatic Affinity within Networks Performing Workload Balancing”, which is hereby incorporated herein by reference.

2. Field of the Invention

The present invention relates to computer networks, and deals more particularly with methods, systems, and computer program products for enabling server applications to explicitly establish an affinity with a particular client (or group of clients) in a computing network, where that network performs workload balancing.

3. Description of the Related Art

The Internet Protocol (“IP”) is designed as a connectionless protocol. Therefore, IP workload balancing solutions treat every Transmission Control Protocol (“TCP”) connection request to a particular application, identified by a particular destination IP address and port number combination, as independent of all other such TCP connection requests. Examples of such IP workload balancing systems include Sysplex Distributor from the International Business Machines Corporation (“IBM”), which is included in IBM's OS/390® TCP/IP implementation, and the Multi-Node Load Balancer (“MNLB”) from Cisco Systems, Inc. (“OS/390” is a registered trademark of IBM.) Workload balancing solutions such as these use relative server capacity (and, in the case of Sysplex Distributor, also network policy information and quality of service considerations) to dynamically select a server to handle each incoming connection request. However, some applications require a relationship between a particular client and a particular server to persist beyond the lifetime of a single interaction (i.e. beyond the connection request and its associated response message).

Web applications are one example of applications which require ongoing relationships. For example, consider a web shopping application, where a user at a client browser may provide his user identifier (“user ID”) and password to a particular instance of the web application executing on a particular server and then shops for merchandise. The user's browser may transmit a number of separate—but related—Hypertext Transfer Protocol (“HTTP”) request messages, each of which is carried on a separate TCP connection request, while using this web application. Separate request messages may be transmitted as the user browses an on-line catalog, selects one or more items of merchandise, places an order, provides payment and shipping information, and finally confirms or cancels the order. In order to assemble and process the user's order, it is necessary to maintain state information (such as the user's ID, requested items of merchandise, etc.) until the shopping transaction is complete. It is therefore necessary to route all of the related connection requests to the same application instance because this state information exists only at that particular web application instance. Thus, the workload balancing implementation must account for on-going relationships of this type and subject only the first connection request to the workload balancing process.

Another example of applications which require persistent relationships between a particular client and a particular server is an application in which the client accesses security-sensitive or otherwise access-restricted web pages. Typically, the user provides his ID and password on an early connection request (e.g. a “log on” request) for such applications. This information must be remembered by the application and carried throughout the related requests without requiring the user to re-enter it. It is therefore necessary to route all subsequent connection requests to the server application instance which is remembering the client's information. The workload balancing implementation must therefore bypass its normal selection process for all but the initial one of the connection requests, in order that the on-going relationship will persist.

The need to provide these persistent relationships is often referred to as “server affinity” or “the sticky routing problem”. One technique that has been used in the prior art to address this problem for web applications is use of “cookies”. A “cookie” is a data object transported in variable-length fields within HTTP request and response headers. A cookie stores certain data that the server application wants to remember about a particular client. This could include client identification, parameters and state information used in an on-going transaction, user preferences, or almost anything else an application writer can think of to include. Cookies are normally stored on the client device, either for the duration of a transaction (e.g. throughout a customer's electronic shopping interactions with an on-line merchant via a single browser instance) or permanently. A web application may provide identifying information in the cookies it transmits to clients in response messages, where the client then returns that information in subsequent request messages. In this manner, the client and server application make use of connection-oriented information in spite of the connection-less model on which HTTP was designed.

However, there are a number of drawbacks to using cookies. First, transmitting the cookie information may increase packet size and may thereby increase network traffic. Second, one can no longer rely on cookies as a means of maintaining application state information (such as client identity) across web transactions. Certain client devices are incapable of storing cookies, These include wireless pervasive devices (such as web phones, personal digital assistants or “PDAs”, and so forth), which typically access the Internet through a Wireless Application Protocol (“WAP”) gateway using the Wireless Session Protocol (“WSP”). WSP does not support cookies, and even if another protocol was used, many of these devices have severely constrained memory and storage capacity, and thus do not have sufficient capacity to store cookies. Furthermore, use of cookies has raised privacy and security concerns, and many users are either turning on “cookie prompting” features on their devices (enabling them to accept cookies selectively, if at all) or completely disabling cookie support.

Other types of applications may have solutions to the sticky routing problem that depend on client and server application cooperation using techniques such as unique application-specific protocols to preserve and transfer relationship state information between consecutive connection lifetimes. For example, the Lotus Notes® software product from Lotus Development Corporation requires the client application to participate, along with the server application, in the process of locating the proper instance of a server application on which a particular client user's e-mail messages are stored. (“Lotus Notes” is a registered trademark of Lotus Development Corporation.) In another cooperative technique, the server application may transmit a special return address to the client, which the client then uses for a subsequent message.

In general, a client and server application can both know when an on-going relationship (i.e. a relationship requiring multiple connections) starts and when it ends. However, the client population for popular applications (such as web applications) is many orders of magnitude greater than the server population. Thus, while server applications might be re-designed to explicitly account for on-going relationships, it is not practical to expect that existing client software would be similarly re-designed and re-deployed (except in very limited situations), and this approach is therefore not a viable solution for the general case.

The sticky routing problem is further complicated by the fact that multiple TCP connections are sometimes established in parallel from a single client, so that related requests can be made and processed in parallel (for example, to more quickly deliver a web document composed of multiple elements). A typical browser loads up to four objects concurrently on four simultaneous TCP connections. In applications where state information is required or desirable when processing parallel requests, the workload balancing implementation cannot be allowed to independently select a server to process each connection request.

One prior art solution to the sticky routing problem in networking environments which perform workload balancing is to establish an affinity between a client and a server by configuring the workload balancing implementation to perform special handling for incoming connection requests from a predetermined client IP address (or perhaps a group of client IP addresses which is specified using a subnet address). This configuring of the workload balancer is typically a manual process and one which requires a great deal of administrative work. Because it is directed specifically to a known client IP address or subnet, this approach does not scale well for a general solution nor does it adapt well to dynamically-determined client IP addresses which cannot be predicted accurately in advance. Furthermore, this configuration approach is static, requiring reconfiguration of the workload balancer to alter the special defined handling. This static specification of particular client addresses for which special handling is to be provided may result in significant workload imbalances over time, and thus this is not an optimal solution.

In another approach, different target server names (which are resolved to server IP addresses) may be statically assigned to client populations. This approach is used by many nation-wide Internet Service Providers (“ISPs”), and requires configuration of clients rather than servers.

Another prior art approach to the sticky routing problem in networking environments which perform workload balancing is to use “timed” affinities. Once a server has been selected for a request from a particular client IP address (or perhaps from a particular subnet), all subsequent incoming requests that arrive within a predetermined fixed period of time (which may be configurable) are automatically sent to that same server. However, the dynamic nature of network traffic makes it very difficult to accurately predict an optimal affinity duration, and use of timed affinities may therefore result in serious inefficiencies and imbalances in the workload. If the affinity duration is too short, then the relationship may be ended prematurely, If the duration is too long, then the purpose of workload balancing is defeated. In addition, significant resources may be wasted when the affinity persists after it is no longer needed.

Accordingly, what is needed is a technique whereby on-going relationships requiring multiple exchanges of related requests over a communications network in the presence of workload balancing can be improved.

### SUMMARY OF THE INVENTION

An object of the present invention is to define improved techniques for handling on-going relationships requiring multiple exchanges of related requests over a communications network in the presence of workload balancing.

Another object of the present invention is to provide this technique with no assumptions or dependencies on a client's ability to support use of cookies.

Still another object of the present invention is to provide this technique without requiring changes to client device software.

A further object of the present invention is to provide this technique whereby a server application sends an explicit notification that an affinity is to begin.

Another object of the present invention is to provide this technique whereby the affinity applies to a particular client, and is established upon receiving a connection request from that client.

Still another object of the present invention is to provide this technique whereby mechanisms may be provided to cancel a server application's affinity.

Yet another object of the present invention is to provide this technique whereby a server application's affinity may be extended under control of the application.

A further object of the present invention is to provide this technique whereby a particular server application's affinity persists for a maximum duration, after which it times out and therefore ends automatically.

An additional object of the present invention is to bypass the workload balancing function only when necessary, as determined by particular server applications.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for handling on-going relationships requiring multiple exchanges of related requests over a communications network in the presence of workload balancing. In a first aspect of one embodiment, this technique comprises: providing server affinities for related connection request messages, comprising: signaling, by an executing server application, that an affinity with a selected source is to be started; and bypassing normal workload balancing operations, responsive to the signaling, for subsequent connection request messages from the selected source while the affinity persists. The selected source may be a selected client, in which case the selected client may be identified by its IP address or perhaps by its IP address and port number. Or, the selected source may be a selected client subnetwork.

The technique may further comprise signaling, by the executing server application, that the started affinity with the selected source is to be ended. In this case, the bypassing of normal workload balancing operations then ceases for subsequent connection request messages from the selected source.

The started affinity may persist for a maximum duration, after which the bypassing of normal workload balancing operations then ceases for subsequent connection request messages from the selected source. In this case, the executing server application may override the maximum duration when signaling the start of the affinity. Each of the subsequent connection request messages preferably automatically extends the maximum duration of the started affinity. Furthermore, the executing server application may extend the started affinity beyond the maximum duration.

The bypassing preferably causes the subsequent connection request messages from the selected source to be routed to an instance of the executing server application which signaled the affinity start.

In another aspect, this technique comprises a method of routing related connection requests by storing information for enforcing one or more currently-active affinities, responsive to receiving start affinity requests for each such currently-active affinity from one or more executing server applications; receiving incoming connection requests from client applications; and routing each received connection request to a proper one of the executing server applications. The routing preferably further comprises: selecting a particular one of the executing server applications using the stored information for enforcing affinities, when the client application sending the received connection request is identified in the stored information as having one of the currently-active affinities with the particular one; and selecting the particular one of the executing server applications using workload balancing otherwise.

The client application may be identified as having one of the currently-active affinities with the particular one if a destination address and destination port, as well as a source address and optionally a source port number, of the connection request being routed match the stored information. The stored information may be removed, responsive to receiving an end affinity request from selected ones of the executing server applications which stored the information and/or responsive to expiration of a duration value for the selected ones.

The present invention may also be used advantageously in methods of doing business, for example in web shopping applications or in other e-business applications having operations or transactions for which improving the handling of related connections proves advantageous.

The present invention will now be described with reference to the following drawings, in which like reference numbers denote the same element throughout.

### BRIEF DESCRIPTION OF THE DRAWINGS

FIG. 1 is a block diagram of a networking environment in which embodiments of the present invention may operate;

FIG. 2A through 2F depict representative message formats that may be used to convey information used by preferred embodiments of the present invention;

FIGS. 3A and 3B illustrate the structure of an “affinity table” that may be used by preferred embodiments of the present invention; and

FIGS. 4 through 11 provide flowcharts depicting logic which may be used to implement preferred embodiments of the present invention.

### DESCRIPTION OF THE PREFERRED EMBODIMENTS

The present invention defines techniques for improving the handling of related connection request messages in networking environments that use workload balancing (which may be referred to equivalently as “load balancing”). Because bypassing the workload balancing function may lead to an overall system in which the workload distribution is out of balance, the disclosed techniques are defined to enable the bypass to occur only when needed by a particular application. Thus, incoming connection requests which do not need this special handling are subjected to workload balancing, as in the prior art, enabling the workload to be shared in a manner that dynamically reacts to the changing networking environment.

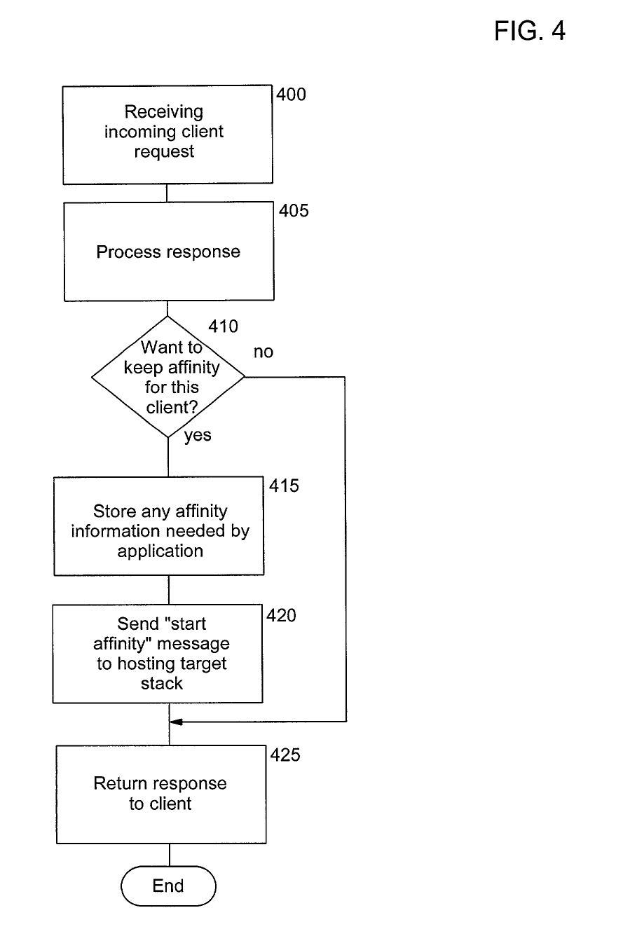

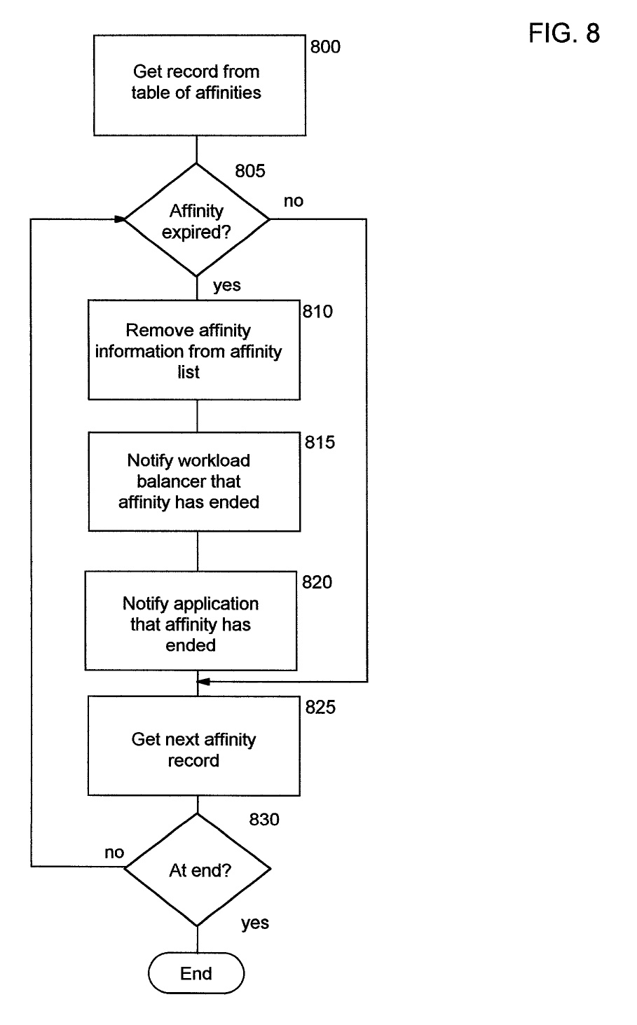

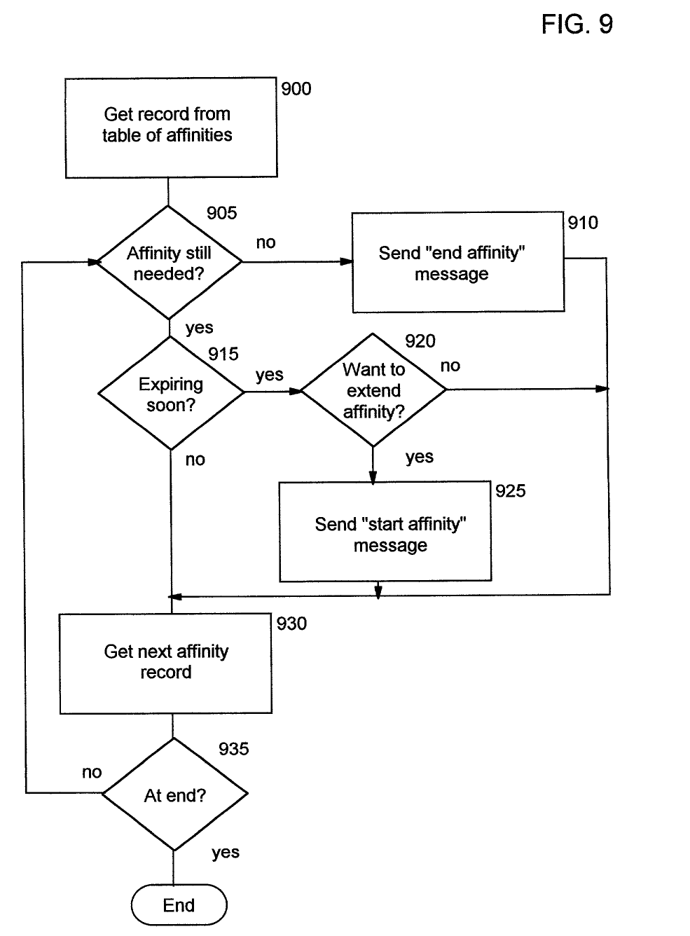

In a first preferred embodiment, the present invention enables an instance of a particular server application to determine dynamically, at run time, whether a relationship with a particular source (e.g. a particular client or subnet) is expected to comprise multiple successive connection requests, and then to specify that those successive requests should be directed to this same server application instance. Preferably, the affinity has a maximum duration, after which the affinity is ended and the resources used to maintain the affinity can be released. A timeout mechanism may be used for this purposes (as will be described in more detail below, with reference to FIGS. 4 and 8). The application instance may also be permitted to explicitly cancel an affinity, or to extend an affinity, using application-specific considerations (as will be described with reference to FIG. 9). Extending an affinity may be useful in a number of situations. For example, an application might be aware that a significant amount of processing for a particular relationship has already occurred, and that it is likely that the processing for this relationship is nearly finished. By extending an affinity, it may be possible to complete the processing (and thereby avoid the inefficiencies encountered in prior art systems which use fixed-duration timed affinities). The ability to cancel an affinity (either explicitly, or because its maximum duration has been exceeded) is especially beneficial in situations where the on-going relationship with the client ends unexpectedly (e.g. because the client application fails, or the user changes his mind about continuing). It may also be desirable to cancel an affinity based upon messages received from the client which indicate that the persistent relationship is no longer necessary.

Note that the affinity duration used for this first preferred embodiment differs from the timed affinity approach which is in use in the prior art. To the best of the inventor's knowledge and belief, in prior art techniques, the affinity duration is constant for all clients served by a particular application (rather than being client-specific, as in this first preferred embodiment), and the prior art provides no technique for enabling an executing server application to explicitly begin and end affinities dynamically using application-specific considerations.

In a second preferred embodiment, the present invention enables instances of a particular server application to specify that connection requests originating from a particular client (and optionally, from specific ports on that client) are to be automatically routed to the same instance of this server application if that instance is currently handling other such requests from the same client. As with the first preferred embodiment, the first of the related connection requests is preferably subjected to normal workload balancing.

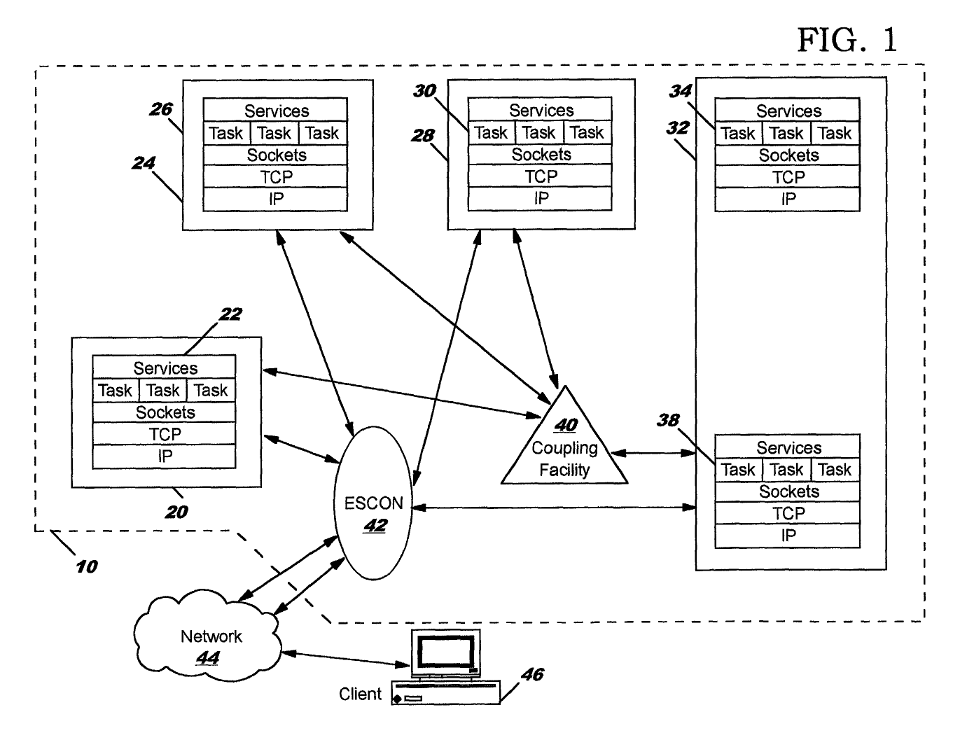

Embodiments of the present invention may operate in a networking environment such as that depicted in FIG. 1. (As will be obvious, this is merely one example of such an environment, and this example is provided for purposes of illustration and not of limitation.) A plurality of data processing systems 20, 24, 28, and 32 are shown as interconnected. This interconnection is referred to herein as a “sysplex”, and is denoted as element 10. The example environment in FIG. 1 illustrates how the present invention may be used with IBM's Sysplex Distributor. However, the teachings disclosed herein may be used advantageously in other networking environments as well, and it will be obvious to one of ordinary skill in the art how these teachings may be adapted to such other environments.

The data processing systems 20, 24, 28, 32 may be operating system images, such as MVS™ images, which execute on one or more computer systems. (“MVS” is a trademark of IBM.) While the present invention will be described primarily with reference to the MVS operating system executing in an OS/390 environment, the data processing systems 20, 24, 28, 32 may be mainframe computers, mid-range computers, servers, or other systems capable of supporting the affinity techniques disclosed herein. Accordingly, the present invention should not be construed as limited to the Sysplex Distributor environment or to data processing systems executing MVS or using OS/390.

As is further illustrated in FIG. 1, the data processing systems 20, 24, 28, 32 have associated with them communication protocol stacks 22, 26, 30, 34, and 38, which for purposes of the preferred embodiments are preferably TCP/IP stacks. As is further seen in FIG. 1, a data processing system such as system 32 may incorporate multiple communication protocol stacks (shown as stacks 34 and 38 in this example). The communication protocol stacks 22, 26, 30, 34, 38 have been modified to incorporate affinity management logic as described herein.

While each of the communication protocol stacks 22, 26, 30, 34, 38 illustrated in FIG. 1 is assumed to incorporate the affinity handling logic, it is not strictly required that all such stacks in a sysplex or networking environment incorporate this logic. Thus, the advantages of the present invention may be realized in a backward-compatible manner, whereby any stacks which do not recognize the affinity messages defined herein may simply ignore those messages.

As is further seen in FIG. 1, the communication protocol stacks 22, 26, 30, 34, 38 may communicate with each other through a coupling facility 40 of sysplex 10. An example of communicating through a coupling facility is the facility provided by the MVS operating system in a System/390 Parallel Sysplex, and known as “MVS XCF Messaging”, where “XCF” stands for “Cross-Coupling Facility”. MVS XCF Messaging provides functions to support cooperation among authorized programs running within a sysplex. When using XCF as a collaboration facility, the stacks preferably communicate with each other using XCF messaging techniques. Such techniques are known in the art, and will not be described in detail herein. The communication protocol stacks 22, 26, 30, 34, 38 may also communicate with an external network 44 such as the Internet, an intranet or extranet, a Local Area Network (LAN), and/or a Wide Area Network (WAN). In an MVS system, an Enterprise Systems Connection (“ESCON”) 42 or other facility may be used for dynamically connecting the plurality of data processing systems 20, 24, 28, 32. A client 46 may therefore utilize network 44 to communicate with an application on an MVS image in sysplex 10 through the communication protocol stacks 22, 26, 30, 34, 38.

Preferably, each of the communication protocol stacks 22, 26, 30, 34, 38 has associated therewith a list of addresses (such as IP addresses) for which that stack is responsible. Also, each data processing system 20, 24, 28, 32 or MVS image preferably has associated therewith a unique identifier within the sysplex 10. At initialization of the communication protocol stacks 22, 26, 30, 34, 38, the stacks are preferably configured with the addresses for which that stack will be responsible, and are provided with the identifier of the MVS image of the data processing system.

Note that while destination addresses within the sysplex are referred to herein as “IP” addresses, these addresses are preferably a virtual IP address of some sort, such as a Dynamic Virtual IP Address (“DVIPA”) of the type described in U.S. Pat. ______ (Ser. No. 09/640,409), which is assigned to IBM and is entitled “Methods, Systems and Computer Program Products for Cluster Workload Distribution”, or a loopback equivalent to a DVIPA, whereby the address appears to be active on more than one stack although the network knows of only one place to send IP packets destined for that IP address. As taught in the DVIPA patent, an IP address is not statically defined in a configuration profile with the normal combination of DEVICE, LINK, and HOME statements, but is instead created as needed (e.g. when needed by Sysplex Distributor),

A workload balancing function such as Workload Management (“WLM”), which is used in the OS/390 TCP/IP implementation for obtaining run-time information about system load and system capacity, may be used for providing input that is used when selecting an initial destination for a client request using workload balancing techniques.

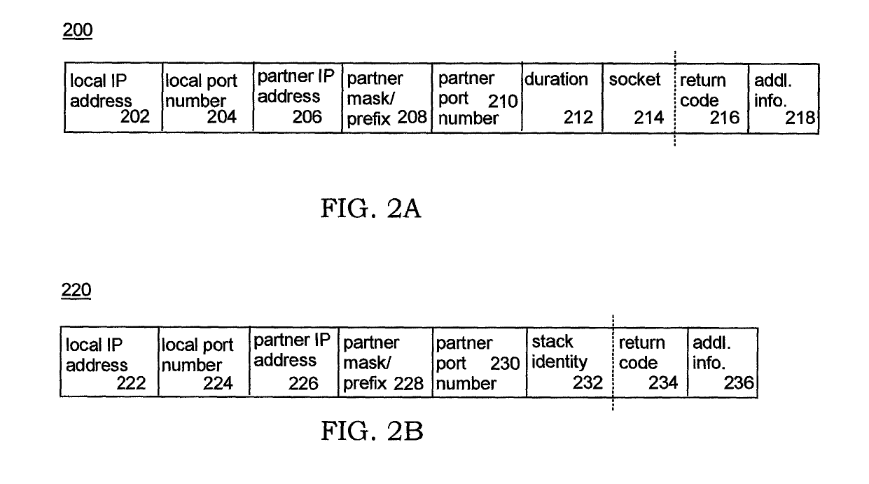

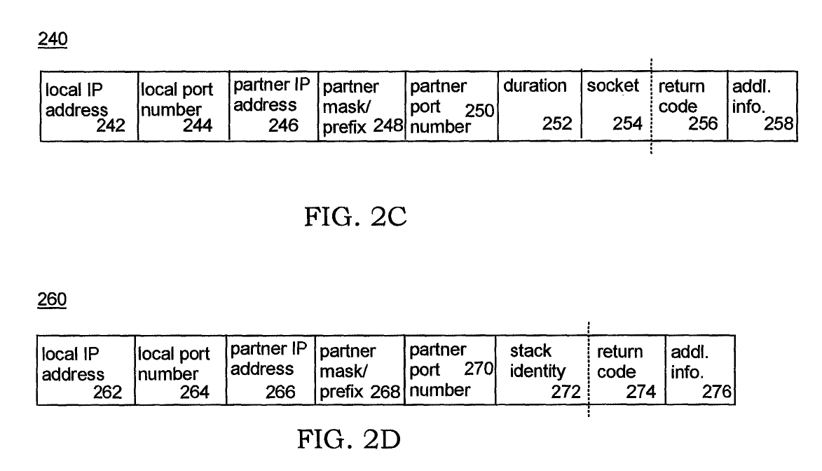

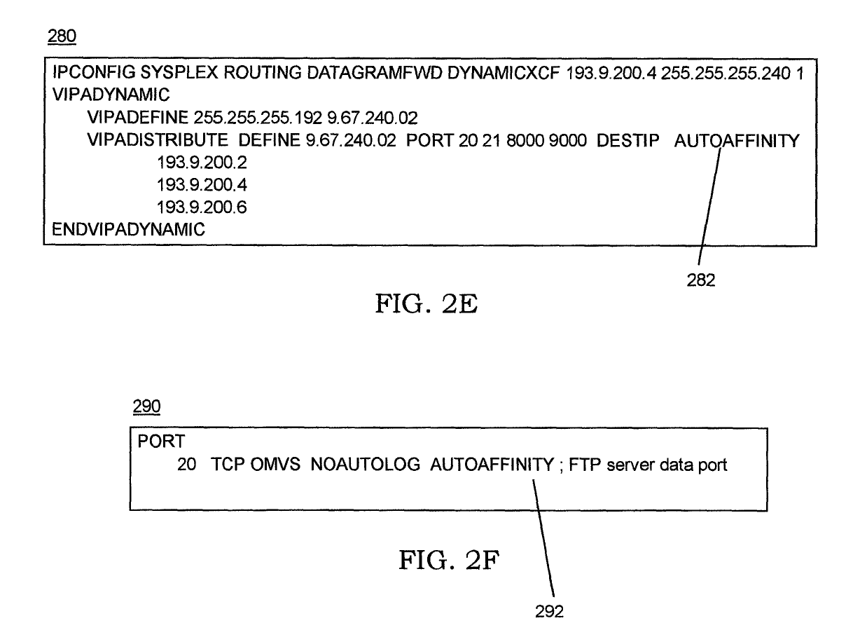

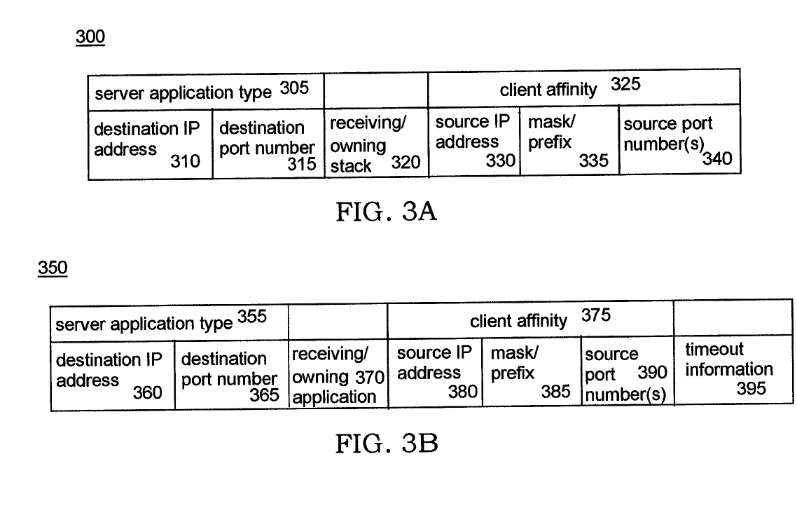

The first and second preferred embodiments will now be described with reference to the message formats illustrated in FIG. 2, the affinity tables illustrated in FIG. 3, and the logic depicted in the flowcharts of FIGS. 4-11.

In the first preferred embodiment, the server application explicitly informs the workload balancing function when a relationship with a particular client starts (as will be described in more detail below, with reference to FIG. 4). Preferably, the client is identified on this “start affinity” message by its IP address. One or more port numbers may also be identified, if desired. When port numbers are specified, the workload balancing function is bypassed only for connection requests originating from those particular ports; if port numbers are omitted, then the workload balancing function is preferably bypassed for connection requests originating from all ports at the specified client source IP address. In this preferred embodiment, the start affinity notification (as well as an optional end affinity message) is preferably sent from the application to its hosting stack, which forwards the message to the workload balancing function. (Hereinafter, a communication protocol stack on which one or more server applications execute is referred to as a “target stack”, a “hosting stack”, or a “target/hosting stack”. A particular stack may be considered a “target” from the point of view of the workload balancer, and a “host” from the point of view of a server application executing on that stack, or both a target and a host when both the workload balancer and a server application are being discussed.)

FIGS. 2A and 2B illustrates a representative format that may be used for the start affinity message. (As will be obvious, the message formats depicted in the examples may be altered in a particular implementation without deviating from the inventive concepts of the present invention. For example, the order of fields may be changed, or additional fields may be added, or perhaps different fields may be used, and so forth.)

Preferably, two sets of messages are used, one set for exchange between an application and its hosting stack and another set for exchange between a target/hosting stack and the workload balancer. Thus, FIG. 2A illustrates a start affinity message 200 to be sent from an application to its hosting stack, and FIG. 2B illustrates a start affinity message 220 to be sent from the hosting stack to the workload balancer. The formats shown may be used for request messages, as well as for the corresponding response messages, as will now be described. (This approach is based upon an assumption that it may be desirable in a particular implementation to define a common format for all affinity messages exchanged between two parties, where fields not required for a particular usage are ignored. This enables efficiently constructing a stop affinity from a start affinity, or generating a response or indication message from its corresponding request message.)

When used as a start affinity request, message format 200 uses fields 202, 204, 206, 208, 210, 212, and 214; fields 216 and 218 are unused. The local IP address field 202 preferably specifies the IP address for which an affinity is being established. The local port number field 204 specifies the port number of the IP address for which this affinity is to be established. If port number field 204 is zero, then all connection requests arriving at the listening socket (see field 214) are covered by this affinity. If the port number field 204 contains a non-zero value, then the affinity applies only to connection requests arriving for that particular port.

The partner IP address field 206 specifies the source IP address of the client to be covered by this affinity. In an optional enhancement, a range of client addresses may be specified for affinity processing. (This enhancement is referred to herein as “affinity group” processing.) In this case, the partner IP address field 206 specifies a subnet address, and a subnet mask or prefix field 208 is preferably used to indicate how many IP addresses are to be covered. (If the high-order bit is “1”, this indicates a subnet mask in normal subnet notation and format. If the high-order is “0”, then the value of field 208 indicates how many “1” bits are to be used for the subnet mask.) The partner port number field 210 may specie a particular port number to be used for the affinity, or alternatively may be zero to indicate that the affinity applies to any connection request from the partner IP address. (In an alternative embodiment, multiple port numbers may be supported, for example by specifying a comma-separated list of values in field 210.)

Duration field 212 specifies the number of seconds for which this affinity should remain active. If set to zero, then the default maximum duration is preferably used. Socket 214 specifies the socket handle for the active listening socket. If field 204 has a non-zero value, then the listening socket must be bound to the port number specified therein.

The following verification is preferably performed on the values of the start affinity request message: (1) The local IP address value 202 must be a valid IP address for which the hosting stack is a valid target for at least one port. (2) The local port value 204, when non-zero, must match an established listening socket. (3) The partner IP address 206 must be non-zero. (4) The partner/mask prefix 208 must be non-zero. (5) If the duration 208 exceeds the default maximum for the hosting stack, then the specified value in field 208 will be ignored. (6) If the socket is bound to a specific IP address, it must be the same as the local IP address in field 202.

When used as a start affinity response, message format 200 uses all fields shown in FIG. 2A. Most fields are simply copied from the corresponding request message when generating the response message; however, several of the fields are used differently, as will now be described. First, if the local port number 204 was zero on the request message, it will be filled in with an actual port number on the response, as determined by the listening socket handle. Second, the return code field 216 is set, and may indicate a successful start affinity or an unsuccessful start, or perhaps a successful start with a warning message. Finally, the additional information field 218 is set, and preferably conveys additional information about the return code value 216. Preferably, unique field value encodings are defined for one or more of the following cases: affinity successfully created; affinity successfully renewed; warning that affinity was not established as requested, and clock was not restarted, because the requested affinity falls within an overlapping affinity for a smaller prefix or larger subnet for which an affinity already exists; unsuccessful because the hosting stack is not a target stack for the specified local IP address; unsuccessful because the requested port does not match the listening socket; unsuccessful because the socket is not a valid listening socket; and unsuccessful because an affinity with the partner IP address was already established by another requester.

Referring now to FIG. 2B, when used as a start affinity request from the hosting stack to the workload balancer, message format 220 uses fields 222, 224, 226, 228, 230, and 232; fields 234 and 236 are unused. Fields 222, 224, 226, 228, and 230 are preferably copied by the hosting stack from the corresponding fields 202, 204, 206, 208, and 210 which were received from the application on its start affinity request message. The local port number 224, however, may either have been supplied by the application or copied from the listening socket information 214. Stack identity 232 identifies the hosting stack to which the subsequent connections covered by the affinity should be sent. The specified value could be a unique names within the sysplex (such as an operating system name and a job name within that operating system), or a unique address such as an IP address; what is required is that the provided identity information suffices to uniquely identify the stack that will handle the incoming connection requests, even if the are multiple stacks per operating system image (such as stacks 34 and 38 in FIG. 1).

When used as a start affinity response, message format 220 uses all fields shown in FIG. 2B. Preferably, fields 222 through 232 are simply copied from the corresponding request message when generating the response message. The return code field 234 is set in the response, and may indicate a successful start affinity or an unsuccessful start, or a successful start with a warning message. The additional information field 236 is also set, and preferably conveys additional information about the return code value 234. Preferably, unique field value encodings are defined for one or more of the following cases: affinity successfully created; affinity successfully renewed; and unsuccessful because an affinity with the partner IP address was already established by another requester.

Preferably, existing affinities that are known to the workload balancing function are stored in a table or other similar structure, such as that illustrated in FIG. 3A. For purposes of illustration but not of limitation, the affinity table may be organized according to the destination server application. As shown in FIG. 3A, the server application type 305 of affinity table 300 preferably comprises (1) the IP address 310 of the server application (which corresponds to the destination IP address of incoming client connection requests) and (2) the port number 315 of that server application (which corresponds to the destination port number of the incoming client connection requests). These values are taken from fields 222 and 224 of start affinity request messages 220 (FIG. 2B). Preferably, if a server application uses multiple ports, then a separate entry is created in affinity table 300 for each such port. (Alternatively, a list of port numbers may be supported in field 315.)

Field 320 identifies the receiving or owning target stack for this affinity, and is used by the workload balancer for routing the incoming connection request messages which match the stored affinity entry to the proper target stack.

Each server application identified by an entry in fields 310, 315 may have an arbitrary number of client affinity entries 325. Each such client affinity entry 325 preferably comprises (1) the client's IP address 330 (which corresponds to the source IP address of incoming client connection requests), (2) a subnet mask or prefix value 335, which is used for comparing incoming client IP addresses to source IP address 330 using known techniques, and (3) optionally, the port number 340 of the client application (which corresponds to the source port number of the incoming client connection requests). These values are taken from fields 226, 228, and 230 of start affinity request messages 220 (FIG. 2B). If the client port number is omitted from a particular start affinity message or is set to zero, indicating that an affinity is defined for all ports from a particular client (as discussed above with reference to FIG. 2A), then a port number of zero is preferably used in field 340 to indicate that all ports are to be considered as matching. Alternatively, the port number field 340 may be left blank, or a special keyword such as “ALL” or perhaps a wildcard symbol such as “*” may be provided as the field value. If multiple client port numbers are specified on the start affinity message, then values for the port number field 340 are preferably stored using a comma-separated list (or perhaps an array or a pointer thereto). In an alternative approach, a separate record might be created in the affinity table for each different client port number.

The table 350 shown in FIG. 3B illustrates a structure that may be used by hosting stacks to manage their existing affinities. As with the table used by the workload balancer and illustrated in FIG. 3A, entries in the affinity table 350 of FIG. 3B may be organized according to the destination server application. Thus, the server application type 355 of affinity table 350 preferably comprises (1) the IP address 360 of the server application and (2) the port number 365 of that server application. These values are taken from fields 202 and 204 of start affinity request messages 200 (FIG. 2A). (Even though the IP address and port number of the server application are contained in the socket control block at the hosting stack, they are preferably stored in the affinity entries as well for efficiency in matching against incoming connection requests.) Preferably, if a server application uses multiple ports, then a separate entry is created in affinity table 350 for each such port.

Field 370 identifies the receiving or owning application for this affinity, and is used by the hosting stack for routing the incoming connection request messages which match the stored affinity entry to the proper application instance. This value may be set to the socket handle of the listening socket, or another identifier such as the process ID or address space ID of the application.

Each server application identified by an entry in fields 360, 365 may have an arbitrary number of client affinity entries 375, where each affinity entry 375 contains analogous information to that described above for affinity entry 325 of FIG. 3A.

Timeout information field 395 may specify an ending date and time for this affinity entry, or alternatively, a starting date and time plus a duration.

Use of the start affinity message and the affinity tables will be discussed in more detail below, with reference to the flowcharts.

Turning now to FIGS. 2C and 2D, an “end affinity” message is illustrated. This end affinity message is not strictly required in an implementation of the present invention, but is preferably provided as an optimization that enables a server application to notify the workload balancing function that a particular affinity has ended and that it is therefore no longer necessary to bypass the workload balancing process for those connection requests (and to notify the hosting stack that it is no longer necessary to bypass port balancing). In addition, the end affinity notification enables the workload balancing function and hosting stack to cease devoting resources to remembering the affinity. Thus, a server application preferably transmits an end affinity message as soon as it determines that an affinity with a particular client (or with one or more ports for a particular client) is no longer needed. In this manner, the workload balancing process is bypassed but only when necessary according to the needs of a particular application. In the optional enhancement which enables use of affinity groups, the end affinity message may specify stopping the affinity for the entire affinity group or for some selected subset thereof

Two sets of end affinity messages are defined, one set for exchange between an application and its hosting stack and another set for exchange between a target/hosting stack and the workload balancer. FIG. 2C illustrates an end affinity message 240 to be exchanged between an application and a hosting stack, and FIG. 2D illustrates an end affinity message 260 to be exchanged between the workload balancer and a hosting stack. The formats shown may be used for request messages, as well as for the corresponding response and indication messages, as will now be described. However, the end affinity response and indication messages used between the target/bosting stack and workload balancer could be omitted (assuming that the target/hosting stack and workload balancer exchange sufficient information that all reasons for ending an affinity, or rejecting an end affinity request, could be learned or inferred from other existing messages.

When used as an end affinity request from an application to a hosting stack, message format 240 uses fields 242, 244, 246, 248, 250, 252, and 254; fields 256 and 258 are unused. The values of these fields are interpreted in an analogous manner to the processing of the start affinity request message 200 of FIG. 2A, in terms of ending an affinity as opposed to starting one, except that duration 252 is preferably ignored and the socket value in field 254 does not have to be a valid and active listening socket if the local port number 244 is non-zero.

When used as an end affinity response from a hosting stack to an application, message format 240 uses all fields shown in FIG. 2C. Fields 242 through 254 are preferably copied from the corresponding request message when generating the response message. The return code field 256 may indicate a successful end affinity or an unsuccessful end. The additional information field 258 is set, and preferably conveys additional information about the return code value 256. Preferably, unique field value encodings are defined for one or more of the following cases: affinity successfully ended; unsuccessful, affinity not ended because the requested affinity falls within an overlapping affinity for a smaller prefix or larger subnet for which an affinity already exists; and unsuccessful because a matching affinity was not found.

When used as an end affinity indication from a hosting stack to an application, message format 240 uses all fields described for the end affinity response, except that field 256 is not meaningful, and field 258 now contains additional information about the reason for the unsolicited indication message. The additional information field 258 preferably uses unique field value encodings for one or more of the following cases to explain why an affinity was ended: timer expiration; the local IP address is no longer valid; hosting stack is no longer a target stack for the local IP address; and the listening socket was closed.

Referring now to FIG. 2D, when used as an end affinity request from the hosting stack to the workload balancer, message format 260 uses fields 262, 264, 266, 268, 270, and 272; fields 274 and 276 are unused. Fields 262 through 272 may be copied by the hosting stack from the corresponding fields 222 through 232 (see FIG. 2B) which were previously sent by this hosting stack to the workload balancer to start the affinity.

When used as an end affinity response from the workload balancer to the hosting stack, message format 260 uses all fields shown in FIG. 2D. Preferably, fields 262 through 272 are simply copied from the corresponding request message when generating the response message. The return code field 274 is set in the response, and may indicate a successful end affinity or an unsuccessful end. The additional information field 276 is also set, and preferably conveys additional information about the return code value 274. Preferably, unique field value encodings are defined for one or more of the following cases: affinity successfully ended; unsuccessful end because the specified affinity falls within an affinity for a smaller prefix or larger subnet for which an affinity already exists, and unsuccessful because matching affinity could not be found.

When used as an end affinity indication from the workload balancer to the hosting stack, message format 260 uses all fields described for the end affinity response, except that field 274 is not meaningful, and field 276 now contains additional information about the reason for the unsolicited indication message. The additional information field 276 preferably uses unique field value encodings for one or more of the following cases to inform the hosting stack why the affinity is being ended: the local IP address is no longer valid; and the hosting stack is no longer a target stack for the local IP address.

Referring again to the server affinity table in FIG. 3A, upon receiving an end affinity message, the workload balancer's affinity table is revised by removing the affinity information identified in that message. Subsequent workload balancing operations will treat incoming requests from the removed client (or the removed port(s) for a client, or the affinity group, as appropriate) as in the prior art, balancing them according to the current conditions of the networking environment. The present invention therefore provides a very dynamic and responsive technique for bypassing workload balancing.

In the second preferred embodiment, simultaneous connections for a particular server application may be directed to the same server application instance automatically, even before the server application might recognize the need for an affinity of the type provided by the first preferred embodiment. This automatic affinity is preferably configurable by server application. There may be situations in which it is not practical to provide an affinity solution which requires modification of server applications. For example, it may be desirable to define affinity relationships for server applications for which no source code is available. Therefore, this second preferred embodiment preferably uses configuration information (rather than messages sent by server application code) to notify the hosting target stack and the workload balancing implementation that a particular server application wishes to activate automatic affinities and thereby avoid the workload balancing process for certain incoming client connection requests.

In this second preferred embodiment, a server application for which automatic affinity processing is activated has an affinity for incoming requests from any client for as long as that client maintains at least one active connection. The affinity with that client then ends automatically, as soon as the client has no active connection. Any subsequent connection from that client is then subject to workload balancing, as in the prior art (but may serve to establish a new automatic affinity, if simultaneous requests from this client are received before that connection ends). This is accomplished without having to provide and maintain per-client configuration information, and without requiring timed affinities as in the prior art.

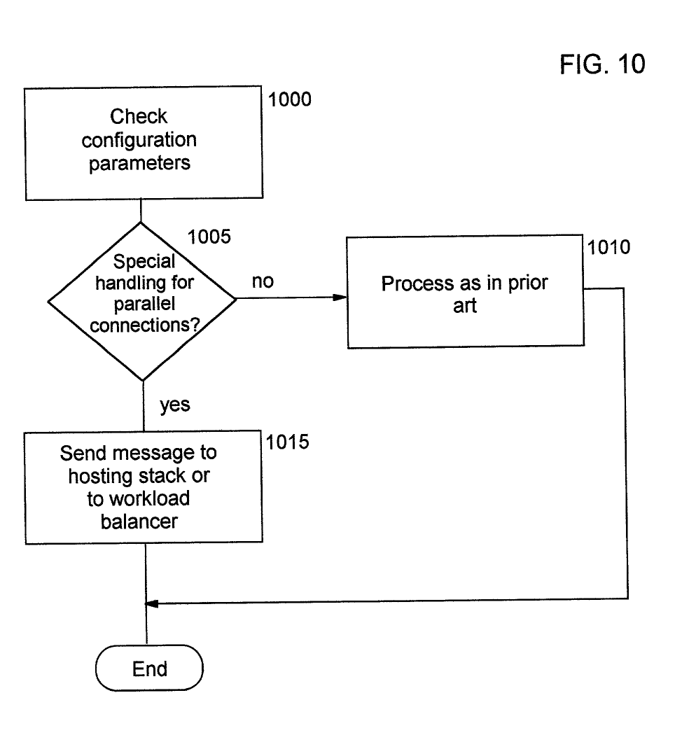

FIGS. 2E and 2F illustrate alternative approaches for a configuration message format that may be used for this second preferred embodiment. Preferably, the information used by the second preferred embodiment is specified as part of an existing configuration message, and thus is propagated from an initializing application (see FIG. 10) to target/hosting stacks and the workload balancer using procedures which are already in place. The configuration statement illustrated in FIG. 2E is the “VIPADISTRIBUTE” statement used for Sysplex Distributor to specify the distribution information for a particular DVIPA and a port or set of ports (i.e. for a particular application). As shown in FIG. 2E, a configuration parameter “AUTOAFFINITY” 282 may be specified for an application to selectively enable operation of the automatic affinities of this second preferred embodiment. Upon receiving an incoming connection request on any of the ports specified on the VIPADISTRIBUTE statement, this preferred embodiment checks to see if an affinity applies. (The other syntax in FIG. 2E is known in the art, and will not be described in detail herein. For a detailed explanation, refer to “1.3.8 Configuring Distributed DVIPAs-Sysplex Distributor”, found in the OS/390 IBM Communications Server V2 R10.0 IP Configuration Guide, IBM document number SC31-8725-01. See also “5.5 Dynamic VIPA Support”, found in the OS/390 IBM Communications Server V2 R10 IP Migration Guide, IBM document number SC31-8512-05.) In an alternative approach, a port reservation configuration statement may be used. An example 290 is illustrated in FIG. 2F, where a configuration parameter “AUTOAFFINITY” 292 is added to specify that an automatic affinity should be established for this port. (More information on the port reservation configuration statement, including an explanation of the remaining syntax in FIG. 2F, may be found in “1.3.29 PORT statement”, OS/390 V2 R6.0 eNetwork CS IP Configuration Guide, IBM document number SC31-8513-01.)

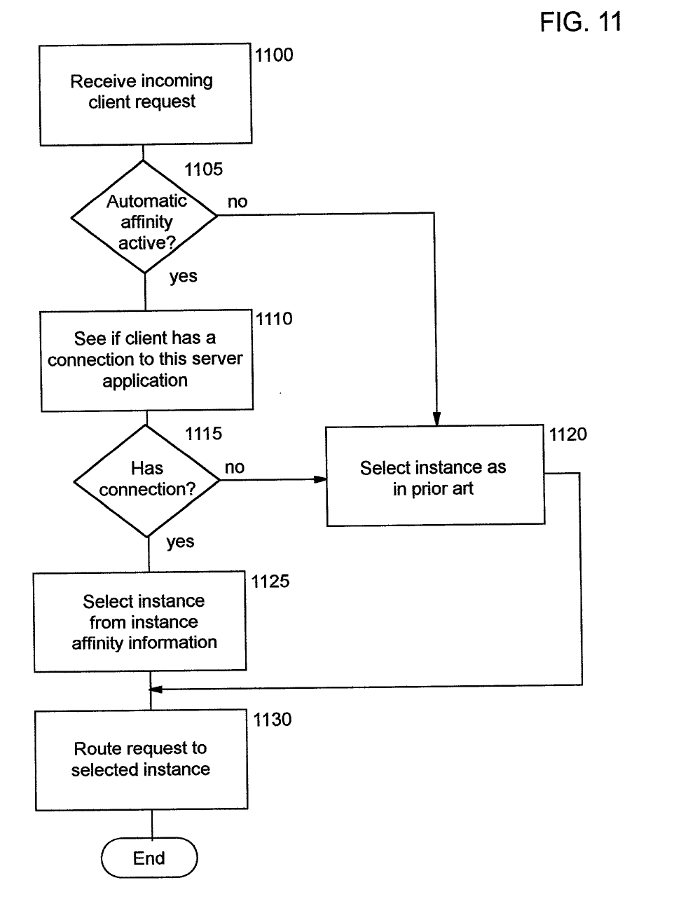

Turning now to the flowcharts provided in FIGS. 4-11, logic is illustrated which may be used to implement preferred embodiments of the present invention. The first preferred embodiment may be implemented using logic shown in FIGS. 4-9, and the second preferred embodiment may be implemented using logic shown in FIGS. 10-11. Furthermore, both embodiments may be implemented in a particular networking environment, if desired, by combining the logic illustrated in both sets of flowcharts.

### FIRST PREFERRED EMBODIMENT

FIG. 4 illustrates logic with which a server application may process an incoming client request, according to the first preferred embodiment. The incoming request is received (Block 400), as in the prior art. When an affinity has not been defined for a particular client (e.g. on the initial one of a series of related requests), this request has received normal workload balancing. In a sysplex environment, the workload balancing function has routed the request to a selected target/hosting stack (such as communication protocol stack 22, 26, 30, 34, or 38 of FIG. 1). Port balancing may also be performed, for a stack which supports multiple application instances sharing a destination port number to enhance server scalability (as in the IBM OS/390 TCP/IP implementation). In this case, the target/hosting stack has selected a particular application instance to receive the connection request. (In the IBM OS/390 TCP/IP port balancing solution, the target/hosting stack balances workload among multiple available application instances according to the number of currently active connections. A new connection goes first to the server application instance having the fewest connections, and then round-robin among several server instances which may have an identical number of connections.) It may alternatively happen that the server application instance receiving the incoming client request in Block 400 has been selected using techniques of the present invention, wherein the workload balancing operation (and the port balancing operation) have been bypassed.

As shown at Block 405, the server application processes the incoming request, according to the requirements of the particular application. The server application then determines (Block 410) whether it should keep an affinity to this client. As has been stated, application-specific considerations (which do not form part of the present invention) are preferably used in making this determination. If no affinity is desired, processing transfers to Block 425. Otherwise, Block 415 stores any affinity information which may be needed by this application. For example, it may be desirable for an application to keep track of which clients have existing affinity relationships defined, and/or the total number of such defined relationships, and so forth. It may also be desirable to store information about when defined affinities will time out. (FIG. 9, described below, provides logic which a server application may optionally use to monitor its defined affinities using stored information about the expiration times thereof.) The format of the start affinity message (to be sent in Block 420) might also be saved, for example for subsequent use if it is necessary to create an end affinity message; this approach may be used advantageously when a message code or identifier for the start affinity needs only to be changed to a different code or identifier to create the associated end affinity message. For performance reasons, it might also be useful for the application to remember whether it has already notified its local hosting stack that an affinity is to be created for a particular client. (However, the application preferably sends a new start affinity message for each incoming request from a client for which an affinity is desired, as will be described in more detail below.)

A start affinity message (see FIG. 2A) is then sent by the application (Block 420). As stated earlier, in the preferred embodiment, this message is sent from the application to its hosting stack (and will then be forwarded to the workload balancer). In an alternative embodiment, the message might be sent directly to a workload balancing function. After processing a start affinity message, or determining that no affinity is desired, Block 425 returns a response to the client and the processing of this client request then ends.

Preferably, a start affinity message is sent for each connection request received from a particular client while an affinity relationship is desired. Clients sometimes terminate without knowledge of the server application. To avoid tying up TCP/IP stack resources for clients that have failed and therefore will never initiate a connection that the server application recognizes as indicating the end of an on-going relationship (such as the final “ship my order” message of a web shopping application), affinities used for this first preferred embodiment are preferably defined as having a maximum duration. If the server application does not explicitly end the affinity before the duration expires, then the affinity will time out and will be cancelled as a result of the timeout event. A default maximum duration (such as 4 hours, or some other time interval appropriate to the needs of a particular networking environment) is preferably enforced by the local hosting stack. The value to be used as the default maximum in a particular implementation may be predetermined, or it may be configurable. Upon detecting a timeout event for an affinity, the affinity information is removed from the stack's affinity table (see 350 of FIG. 3B) and an end affinity message is preferably sent to the workload balancer, which removes the affinity from its own affinity table (see 300 of FIG. 3A). See FIG. 8, described below, for logic which may be used to implement this timer processing in a hosting stack.

Optionally, a server application may be allowed to specify an affinity duration on the start affinity message. In the preferred embodiment, the specified affinity duration value must be less than the default maximum and then overrides that default value. (If the specified affinity duration is not less than the default maximum, then the default maximum is preferably substituted for the duration specified by the application.) By sending a new start affinity message for each related connection request, it is not necessary to “renew” affinities that may last beyond the default maximum or the specified maximum, as appropriate, so long as at least one connection request arrives from that particular client no longer than the default maximum or specified maximum time since the last such connection. If the interval since the last connection request exceeds the appropriate maximum duration, then the hosting stack preferably cancels the affinity, notifies the workload balancer to do likewise, and preferably also notifies the application that the affinity has expired. (Subsequent connection requests from this client will then be subject to workload balancing, until such time as the server application may re-establish a new affinity with this client.) On the other hand, the server application may optionally be allowed to extend an affinity, as described below with reference to FIG. 9, to prevent the hosting stack from cancelling it.

The start affinity message may be sent from the server application to its local hosting stack over a “control socket”. As used herein, a control socket is a bi-directional communications socket established between a server application and its hosting stack, Preferably, a server application establishes this control socket when it initializes, along with the normal server listening socket that is used for receiving client requests. However, the control socket provides a control conduit to the server application's hosting TCP/IP stack, rather than a communication vehicle to other applications. Preferably, the destination IP address and port number of the server application are provided as parameters when establishing the control socket. Once the control socket is established, the start affinity message (see Block 420), as well as any subsequent end affinity message, is preferably transmitted using that control socket.

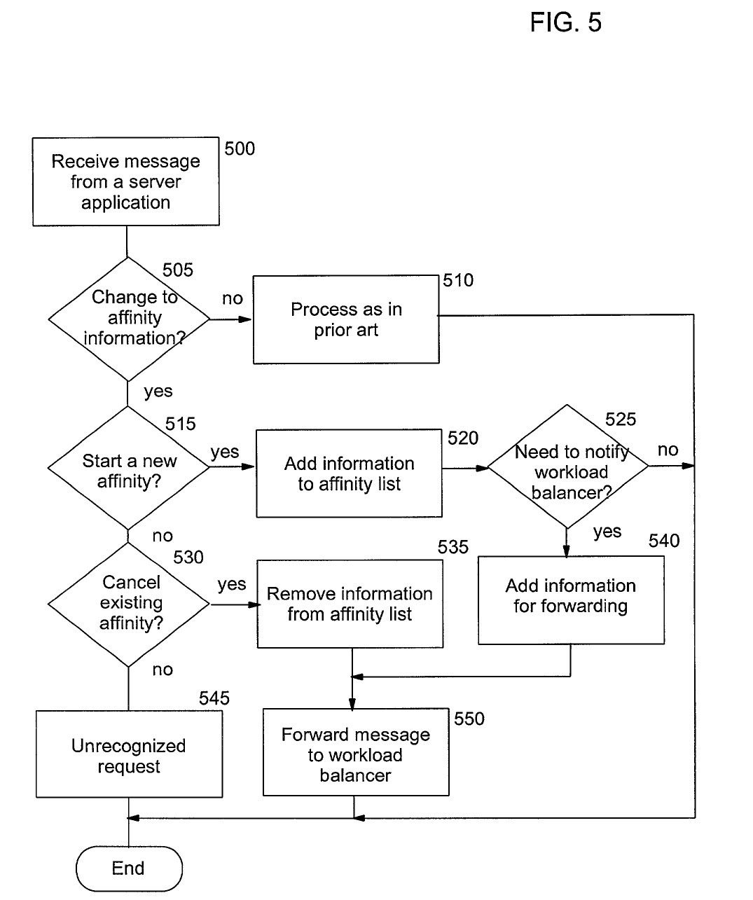

FIG. 5 illustrates logic that may be used in a hosting stack to process affinity messages received from server applications. Such messages may be received over the control socket, as has been described. At Block 500, a message from a server application is received. Block 505 then checks to see if this message is requesting a change to affinity information. If not, then the message is preferably processed as in the prior art (as indicated in Block, 510), after which the logic of FIG. 5 is complete for this message. Otherwise, Block 515 tests whether this is a start affinity message. If so, then in Block 520 the information from the message is added to the hosting stack's stored affinity information (see FIG. 3B). The affinity information stored by the hosting stack enables, inter alia, routing subsequent incoming client requests to the proper application instance when multiple such instances of a particular application may be executing on this target/hosting stack (e.g. by bypassing the port balancing process).

Block 525 then checks to see if it is necessary to notify the workload balancer that this affinity has been started. If the affinity is new (as contrasted to an existing affinity for which a subsequent affinity request has arrived, and which is therefore being renewed by restarting the duration timer), then this test has a positive result and Block 540 adds this target stack's identity information (e.g. its job name and operating system name, or a unique IP address associated with the target stack) to a version of the start affinity message that is then forwarded (in Block 550) to the workload balancer. On the other hand, if this affinity is one which is being renewed, and if all timer expiration processing is being handled by the hosting stack, then it is not necessary to forward a (renewing) start affinity message to the workload balancer as no new information would be communicated. In this case, the test in Block 525 has a negative result, and control preferably exits the processing of FIG. 5.

If the message is not a start affinity message, then Block 530 checks to see if it is an end affinity message. If it is, then at Block 535 the corresponding affinity information is deleted from the local stack's stored affinity information. This stack's information is preferably added to a version of the end affinity message, as described above with reference to Block 540, after which the message is forwarded to the workload balancer (Block 550). (Note that in certain cases, such as when an end affinity request is rejected, it may be preferably to omit forwarding a message to the workload balancer; it will be obvious to one of skill in the art how the logic shown in FIG. 5 can be adapted for such cases.) Subsequent requests from this client for the application may then undergo port balancing as well as workload balancing.

If the message is neither a start affinity or an end affinity message, then as shown at Block 545, the message is preferably treated as an unrecognized request (for example, by generating an error message or logging information to a trace file).

Following operation of Block 510, 525, 550, or 545, the processing of FIG. 5 then ends for the current message.

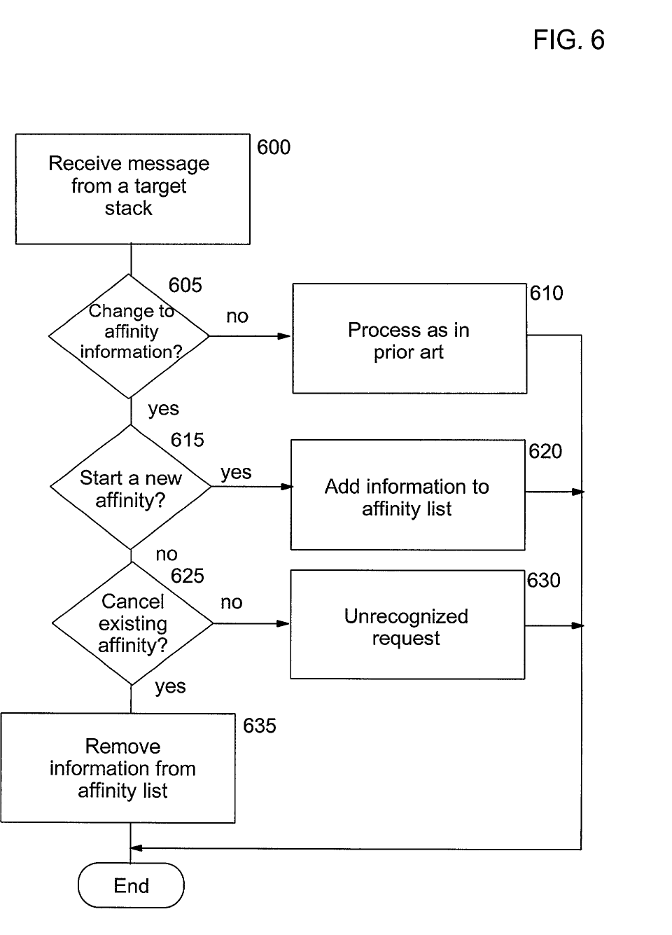

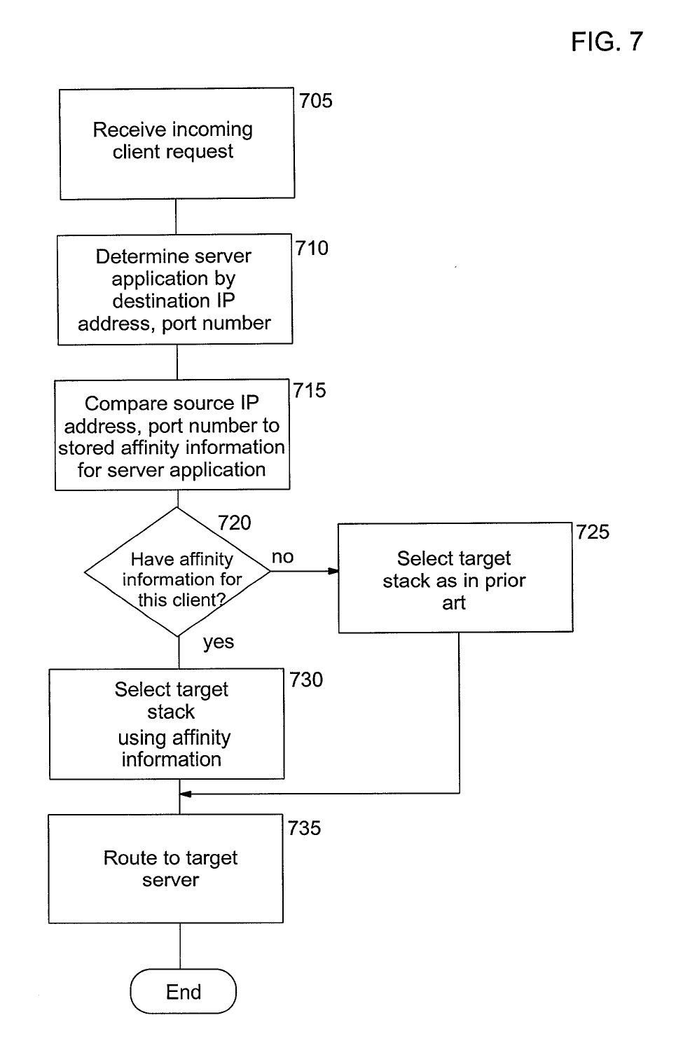

FIG. 6 is quite similar to FIG. 5, but illustrates logic that may be used in the workload balancer to process affinity messages received from a target/hosting stack. A message is received (Block 600), and checked (Block 605) to see if it requests a change to affinity information. If not, then the message is preferably processed as in the prior art (as indicated in Block 610), after which the logic of FIG. 6 is complete for this message. Otherwise, Block 615 tests whether this is a start affinity message. If so, then in Block 620 the information from the message is added to the workload balancer's stored affinity information. (See FIG. 3A for a description of the stored affinity table of the workload balancer.) The affinity information stored by the workload balancer will be used for routing subsequent incoming client requests to the proper target stack (as will be described with reference to FIG. 7).

If the message is not a start affinity message, then Block 625 checks to see if it is an end affinity message. If it is, then at Block 635 the corresponding affinity information is deleted from the workload balancer's stored affinity information.

If the message is neither a start affinity or an end affinity message, then as shown at Block 630, the message is preferably treated as an unrecognized request (for example, by generating an error message or logging information to a trace file).

Following operation of Block 610, 620, 630, or 635, the processing of FIG. 6 then ends for the current message.

The logic in FIG. 7 illustrates affinity processing that may be performed when a workload balancer receives incoming client connection requests. A client request is received (Block 705) from a client application (such as client 46 of FIG. 1). The target server application is then determined (Block 710) by examining the destination IP address and port number. This information is compared to the workload balancer's stored affinity information (Block 715) to determine if affinities for this application have been defined. With reference to FIG. 3A, this comprises determining whether affinity table 300 has entries 310, 315 matching the destination information from the incoming connection request. If so, then the source IP address and port number are compared to the stored affinity information for that application. If an entry for this source IP address exists in field 330 of the client affinity information 325 (and matches according to the mask or prefix value stored in field 335), for the target application, and if the source port number of the incoming request either matches a port number specified in field 340 or the entry in field 340 indicates that all port numbers are to be considered as matching, then this is a client request for which a server affinity has been defined. In this case, the test in Block 720 has a positive result, and in Block 730 the target server is selected using the receiving/owning stack field 320; otherwise, when Block 715 fails to find a matching entry in the affinity table, then Block 720 has a negative result and the target server is selected (Block 725) as in the prior art (e.g. using the normal workload balancing process).

After the target server has been selected by Block 725 or Block 730, the client's request is forwarded to that server (Block 735), and the processing of FIG. 7 then ends for this incoming connection request.

Processing analogous to that shown in FIG. 7 may be used in the selected target/hosting stack for handling incoming client requests and determining whether port balancing should be performed, except that Blocks 725 and 730 select a target application instance (rather than a target stack).

The logic depicted in FIG. 8 may be used in hosting stacks to control affinity durations for the application instances which they are hosting. As stated earlier, if a server application does not explicitly end an affinity before the maximum affinity duration is exceeded, then the hosting stack cancels that affinity. This timer processing is preferably handled by periodically examining each entry in the hosting stack's affinity table (such as table 350 in FIG. 3B), as shown in FIG. 8. Block 800 therefore obtains an entry from the stack's affinity table. Block 805 then checks to see if this affinity has expired by evaluating the timeout information 395. This timeout information may comprise an ending date and time for the affinity, or alternatively, a starting date and time and a duration. In either case, the stored information is compared to the current date and time. If this comparison indicates that the affinity has expired, then Block 810 removes the entry for this affinity from the affinity table. Block 815 then notifies the workload balancer that the affinity has ended; this notification is processed according to the logic in FIG. 6, as has been described. If the implementation supports generation of explicit end affinity messages by server applications, then a notification is preferably also sent (Block 820) to the application identified by field 370 of the expired affinity's stored record.

After processing the expired affinity, and also when the affinity was not expired, Block 825 obtains the next affinity record. Block 830 then checks to see if the last affinity record has already been examined. If so, the processing of FIG. 8 is complete; otherwise, control returns to Block 805 to iterate through the evaluation process for this next affinity record.

In an alternative implementation, the affinity duration processing may be handled by the workload balancing host rather than by hosting stacks, if desired (although the preferred embodiment locates the function at the hosting stacks to spread processing overhead). It will be obvious how the messages, affinity tables, and logic may be adapted to support this alternative processing.

FIG. 9 illustrates logic which may be used to explicitly end selected affinities. (Affinities may also end based upon expiration of timers, as has been discussed.) Support for an explicit end affinity message is optional, but preferred, as has been stated. When supported, this logic is preferably implemented in a server application.

The present invention enables a server application to send an end affinity message based upon application-specific considerations. For example, in a web shopping application, the application may detect that the user has pressed an “empty my shopping cart” button on a web page, indicating that the state information for the shopping transaction is no longer needed and that the client's affinity to a particular server application instance is no longer necessary. (This type of processing may optionally be added to the logic in FIG. 4, for example by determining whether an affinity already exists that is no longer needed during the processing of Block 405.) Or, an application may know the characteristics of its typical interactions with clients (such as the typical number of message exchanges, average delay between messages, and so forth). In this case, the application may use this characteristic information to determine that a relationship with an individual client has likely failed, and may then choose to explicitly end the affinity before waiting for it to time out.

To enable accounting for scenarios of the latter type, which are not typically tied to receipt of an incoming message, the processing of FIG. 9 may be invoked periodically as a type of “clean up” operation of the application's affinities. Timer-driven means may be used to initiate the invocation, or an event (such as exceeding a predetermined threshold or perhaps reaching a capacity for stored affinity information) may be used alternatively. FIG. 9 is therefore depicted as cycling through all the affinities that are in place for a particular application.

At Block 900, the first record from the affinity table for the application is obtained. Block 905 tests to see if this affinity is still needed. If not, Block 910 sends an end affinity message from the application to the local hosting stack. Preferably, this message is transmitted over the control socket. The local hosting stack will then remove the bypass of the port balancing operation for that client and forward the request to the workload balancer (as has been described with reference to Blocks 535 and 550 of FIG. 5), which will remove its bypass of workload balancing for that client (as has been described with reference to Block 635 of FIG. 6).

If the test in Block 905 has a positive result (i.e. the affinity is still needed), then Blocks 915 through 925 perform an optional affinity extension process. Block 915 checks to see if the affinity will be expiring soon. (As stated earlier, an application may remember information about its affinities, including their expiration times; Block 915 preferably compares this remembered expiration information to an application-specific “close to expiring” value.) If so, then Block 920 checks to see if it is desirable to extend the affinity. (As previously discussed, an application may have knowledge that a particular relationship is nearly complete, and could complete successfully if the affinity was extended.) If this is the case, Block 925 sends a start affinity message to the local hosting stack.

Block 930 obtains the next affinity record for this application. Block 935 checks to see if the last such record has been processed. If so, then this invocation of the logic of FIG. 9 ends; otherwise, control returns to Block 905 to iteratively process the next record.

In an optional security enhancement of this first preferred embodiment, only a server application which already has at least one active connection with a particular client may be allowed to start an affinity for future requests from that same client. In OS/390 implementations, this security enhancement may alternatively be provided by requiring a server application to have an existing port reservation configured in the stack before start affinity requests are accepted from that application. In this manner, “rogue” applications are prevented from takeover attacks whereby malicious application code diverts connections with a particular client away from a legitimate target server application.

### SECOND PREFERRED EMBODIMENT

FIG. 10 illustrates logic which may be used when a server application instance that will make use of automatic affinity processing for concurrent connection requests from particular clients initializes. This processing is preferably performed as each server application instance initializes, and may be selectively enabled or disabled through use of configuration parameters for that application. Block 1000 thus checks the configuration parameters which have been defined for the application, and Block 1005 tests whether these parameters specify special automatic affinity handling for parallel (i.e. concurrent) connections. If this test has a negative result, then the initialization continues as in the prior art (Block 1010); otherwise, Block 1015 preferably includes a parameter to activate automatic affinity processing on an existing configuration message that will be sent to the workload balancer or, alternatively, to the hosting stack, where this parameter serves to notify the workload balancer or hosting stack that automatic affinity processing is active for this application instance. When using the enhanced VIPADISTRIBUTE configuration statement depicted in FIG. 2E, Block 1015 sends the configuration message to the workload balancer, which then notifies the target stacks using procedures which exist in the prior art. When using the enhanced PORT statement illustrated in FIG. 2F, Block 1015 sends the configuration message to the hosting stack. The hosting stack is responsible for forwarding the appropriate notification to the workload balancer. If the affinity is configured on multiple hosting stacks, then duplicate notification messages may be received at the workload balancer (even though the notifications other than the first will be redundant).

Processing analogous to that shown in FIG. 7 may be used for handling incoming client connection requests in the workload balancer for this second preferred embodiment as well (enabling them to bypass the workload balancing process if an affinity is in effect), except that the test in Block 720 (i.e. determining whether there is an affinity for this client) has slightly different semantics. For the second preferred embodiment, this test comprises determining whether (1) automatic affinity processing has been activated for the target server application (e.g. using the technique described with reference to FIG. 10) and (2) there are any existing active connection requests for this client. If both of these conditions are true, then the test in Block 720 has a positive result and the target stack selected in Block 730 is that one which is already processing the active connection requests.

If the same affinity table structure defined for the first preferred embodiment (see tables 300 and 350 of FIGS. 3A and 3B) is used to maintain affinity information for this second preferred embodiment, then a special value such as zero is preferably used for the timeout information 395 stored at the target host for all automatic affinities. This special value identifies an active affinity that is not ended using timers. (As will be obvious, the special value then cannot be allowed for affinities defined according to the first preferred embodiment.) Alternatively, affinity structures tailored to this embodiment may be used if desired, which omit the timeout information field 395, the mask/prefix field 335, and the mask/prefix field 385 but are otherwise equivalent to the tables shown in FIGS. 3A and 3B.

FIG. 11 depicts logic that may be used in the selected target/hosting stack for handling incoming client requests and determining whether port balancing should be performed. At Block 1100, an incoming client request is received. Block 1105 then locates the client IP address and port number, and the destination IP address and port number, from that request and checks to see if automatic affinity processing is activated for the target application. If not, then control transfers to Block 1120 which selects an instance as in the prior art. Otherwise, Block 1110 checks the active connections for the target application to determine whether this client already has at least one active connection to that same application. If so, then Block 1125 selects the target application instance to be the same one already in use; otherwise, Block 1120 selects an instance as in the prior art (e.g. using port balancing). In either case, Block 1130 the routes the incoming request to the selected instance, and the processing of FIG. 11 is then complete for this incoming message.

As has been demonstrated, the present invention provides advantageous techniques for improving affinity in networking environments which perform workload balancing. No changes are required on client devices or in client software, and no assumptions or dependencies are placed on a client's ability to support cookies. Minimal server programming is required, providing a solution that is easy for servers to implement and which does not require any fundamental change to the structure of the server programming model. Normal workload balancing is bypassed only when necessary, and there is no reduction in flexibility of deploying server application instances.

As will be appreciated by one of skill in the art, embodiments of the present invention may be provided as methods, systems, and/or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While preferred embodiments of the present invention have been described, additional variations and modifications in those embodiments may occur to those skilled in the art once they learn of the basic inventive concepts. In particular, while the preferred embodiments have been described with reference to TCP and IP, this is for purposes of illustration and not of limitation. Therefore, it is intended that the appended claims shall be construed to include both the preferred embodiments and all such variations and modifications as fall within the spirit and scope of the invention.

What is claimed is:

1. A method of providing server affinities for related connection request messages in networking environments which perform workload balancing, comprising steps of:
signaling, by an executing server application, that an affinity with a selected source is to be started; and
bypassing normal workload balancing operations, responsive to the signaling, for subsequent connection request messages from the selected source while the affinity persists.

2. The method according to claim 1, wherein the selected source is a selected client.

3. The method according to claim 2, wherein the selected client is identified by its Internet Protocol (“IP”) address.

4. The method according to claim 2, wherein the selected client is identified by its Internet Protocol (“IP”) address and port number.

5. The method according to claim 1, wherein the selected source is a selected client subnetwork.

6. The method according to claim 1, further comprising the step of signaling, by the executing server application, that the started affinity with the selected source is to be ended; and wherein the step of bypassing normal workload balancing operations then ceases for subsequent connection request messages from the selected source.

7. The method according to claim 1, wherein the started affinity persists for a maximum duration, after which the step of bypassing normal workload balancing operations then ceases for subsequent connection request messages from the selected source.

8. The method according to claim 7, wherein the executing server application may override the maximum duration when signaling the start of the affinity.

9. The method according to claim 7, wherein each of the subsequent connection request messages automatically extends the maximum duration of the started affinity.

10. The method according to claim 9, further comprising the step of extending, by the executing server application, the started affinity beyond the maximum duration.

11. The method according to claim 1, wherein the bypassing step causes the subsequent connection request messages from the selected source to be routed to an instance of the executing server application which signaled the affinity start.

12. A method of routing related connection requests in a networking environment which performs workload balancing, comprising steps of:
storing information for enforcing one or more currently-active affinities, responsive to receiving start affinity requests for each such currently-active affinity from one or more executing server applications;
receiving incoming connection requests from client applications; and
routing each received connection request to a proper one of the executing server applications, further comprising steps of:
selecting a particular one of the executing server applications using the stored information for enforcing affinities, when the client application sending the received connection request is identified in the stored information as having one of the currently-active affinities with the particular one; and
selecting the particular one of the executing server applications using workload balancing otherwise.

13. The method according to claim 12, wherein the client application is identified as having one of the currently-active affinities with the particular one if a destination address and destination port, as well as a source address and optionally a source port number, of the connection request being routed match the stored information.

14. The method according to claim 12, further comprising the step of removing stored information for enforcing selected ones of the currently-active affinities, responsive to receiving an end affinity request from selected ones of the executing server applications which stored the information.

15. The method according to claim 12, further comprising the step of removing stored information for enforcing selected ones of the currently-active affinities, responsive to expiration of a duration value for the selected ones.

16. A system for providing server affinities for related connection request messages in networking environments which perform workload balancing, comprising:
means for signaling, by an executing server application, that an affinity with a selected source is to be started; and
means for bypassing normal workload balancing operations, responsive to the signaling, for subsequent connection request messages from the selected source while the affinity persists.

17. The system according to claim 16, further comprising means for signaling, by the executing server application, that the started affinity with the selected source is to be ended; and wherein the means for bypassing normal workload balancing operations then ceases for subsequent connection request messages from the selected source.

18. The system according to claim 16, wherein the started affinity persists for a maximum duration, after which the means for bypassing normal workload balancing operations then ceases for subsequent connection request messages from the selected source.

19. The system according to claim 18, wherein the executing server application may override the maximum duration when signaling the start of the affinity.

20. The system according to claim 18, wherein each of the subsequent connection request messages automatically extends the maximum duration of the started affinity.

21. The system according to claim 20, further comprising means for extending, by the executing server application, the started affinity beyond the maximum duration.

22. The system according to claim 16, wherein the means for bypassing causes the subsequent connection request messages from the selected source to be routed to an instance of the executing server application which signaled the affinity start.

23. A system for routing related connection requests in a networking environment which performs workload balancing, comprising:
means for storing information for enforcing one or more currently-active affinities, responsive to receiving start affinity requests for each such currently-active affinity from one or more executing server applications;
means for receiving incoming connection requests from client applications; and
means for routing each received connection request to a proper one of the executing server applications, further comprising:
means for selecting a particular one of the executing server applications using the stored information for enforcing affinities, when the client application sending the received connection request is identified in the stored information as having one of the currently-active affinities with the particular one; and
means for selecting the particular one of the executing server applications using workload balancing otherwise.

24. The system according to claim 23, wherein the client application is identified as having one of the currently-active affinities with the particular one if a destination address and destination port, as well as a source address and optionally a source port number, of the connection request being routed match the stored information.

25. The system according to claim 23, further comprising means for removing stored information for enforcing selected ones of the currently-active affinities, responsive to receiving an end affinity request from selected ones of the executing server applications which stored the information.

26. The system according to claim 23, further comprising means for removing stored information for enforcing selected ones of the currently-active affinities, responsive to expiration of a duration value for the selected ones.

27. A computer program product for providing server affinities for related connection request messages in networking environments which perform workload balancing, the computer program product embodied on one or more computer readable media and comprising:
computer readable program code means for signaling, by an executing server application, that an affinity with a selected source is to be started; and
computer readable program code means for bypassing normal workload balancing operations, responsive to the signaling, for subsequent connection request messages from the selected source while the affinity persists.

28. The computer program product according to claim 27, further comprising computer readable program code means for signaling, by the executing server application, that the started affinity with the selected source is to be ended; and wherein the computer readable program code means for bypassing normal workload balancing operations then ceases for subsequent connection request messages from the selected source.

29. The computer program product according to claim 27, wherein the started affinity persists for a maximum duration, after which the computer readable program code means for bypassing normal workload balancing operations then ceases for subsequent connection request messages from the selected source.

30. The computer program product according to claim 29, wherein the executing server application may override the maximum duration when signaling the start of the affinity.

31. The computer program product according to claim 29, wherein each of the subsequent connection request messages automatically extends the maximum duration of the started affinity.

32. The computer program product according to claim 30, further comprising computer readable program code means for extending, by the executing server application, the started affinity beyond the maximum duration.

33. The computer program product according to claim 27, wherein the computer readable program code means for bypassing causes the subsequent connection request messages from the selected source to be routed to an instance of the executing server application which signaled the affinity start.

34. A computer program product for routing related connection requests in a networking environment which performs workload balancing, the computer program product embodied on one or more computer readable media and comprising:
computer readable program code means for storing information for enforcing one or more currently-active affinities, responsive to receiving start affinity requests for each such currently-active affinity from one or more executing server applications;
computer readable program code means for receiving incoming connection requests from client applications; and
computer readable program code means for routing each received connection request to a proper one of the executing server applications, further comprising:
computer readable program code means for selecting a particular one of the executing server applications using the stored information for enforcing affinities, when the client application sending the received connection request is identified in the stored information as having one of the currently-active affinities with the particular one; and
computer readable program code means for selecting the particular one of the executing server applications using workload balancing otherwise.

35. The computer program product according to claim 34, wherein the client application is identified as having one of the currently-active affinities with the particular one if a destination address and destination port, as well as a source address and optionally a source port number, of the connection request being routed match the stored information.

36. The computer program product according to claim 34, further comprising computer readable program code means for removing stored information for enforcing selected ones of the currently-active affinities, responsive to receiving an end affinity request from selected ones of the executing server applications which stored the information.

37. The computer program product according to claim 34, further comprising computer readable program code means for removing stored information for enforcing selected ones of the currently-active affinities, responsive to expiration of a duration value for the selected ones.
